(19) United States
(12) Patent Application Publication
(10) Pub. No.: US 2026/0329501 A1
(43) Pub. Date: Oct. 22, 2026

(54) PROCESSING CONTROL APPARATUS AND PROCESSING CONTROL METHOD

(71) Applicant: Roland DG Corporation, Hamamatsu-shi (JP)

(72) Inventors: Kazumasa KAMBAYASHI, Hamamatsu-shi (JP); Yoshinari OGURA, Hamamatsu-shi (JP); Yasuhito FUJITA, Hamamatsu-shi (JP); Yuki OKADO, Hamamatsu-shi (JP); Kosei OHASHI, Hamamatsu-shi (JP); Teito OKOSHI, Hamamatsu-shi (JP)

(21) Appl. No.: 19/719,622

(22) Filed: Jun. 25, 2026

Related U.S. Application Data
(63) Continuation of application No. PCT/JP2024/043961, filed on Dec. 12, 2024.

(30) Foreign Application Priority Data
Dec. 26, 2023 (JP) 2023-219704

(51) Int. Cl. G06F 3/12

(52) U.S. Cl. CPC G06F 3/1262; G06F 3/1203; G06F 3/1264

(57) ABSTRACT

A processing control apparatus that controls a processing apparatus capable of executing first processing and second processing different from the first processing, includes a computer or processor configured or programmed to include an acquirer configured or programmed to acquire a job group including a plurality of jobs including a job that includes first processing data to execute the first processing and second processing data to execute the second processing and a job that includes at least one of the first processing data or the second processing data, a first command generator configured or programmed to cause the processing apparatus to collectively execute the first processing corresponding to the first processing data included in the job group, and a second command generator configured or programmed to cause the processing apparatus to collectively execute the second processing corresponding to the second processing data included in the job group.

### CROSS-REFERENCE TO RELATED APPLICATIONS

This is a continuation application of International Patent Application No. PCT/JP2024/043961 filed Dec. 12, 2024, which claims the benefit of priority to Japanese Patent Application No. 2023-219704 filed Dec. 26, 2023, the entire contents of each of which are hereby incorporated herein by reference.

### BACKGROUND OF THE INVENTION

### 1. Field of the Invention

The present disclosure relates to processing control apparatuses and processing control methods.

### 2. Description of the Related Art

Japanese Patent Application Publication No. 2017-217811 describes a processing apparatus that prints an image on a medium and cuts the medium. Japanese Patent Application Publication No. 2017-217811 also describes that, when multiple jobs are collectively processed by the processing apparatus by aggregating multiple sets of job data, job data that includes cut data is extracted from the multiple sets of the job data to create a cut job group, job data that does not include cut data is extracted from the multiple sets of the job data to create a non-cut job group, and a cut region that is based on the cut data included in the cut job group is arranged downstream in a direction of transport of a print region that is based on image data included in the non-cut job group.

In the case where the multiple jobs including jobs to execute first processing (for example, printing) and second processing (for example, cutting) different from the first processing are collectively processed by the processing apparatus and when the first processing and the second processing are frequently switched, processing accuracy and processing efficiency may be degraded.

### SUMMARY OF THE INVENTION

Example embodiments of the present disclosure reduce switching between different types of processing when multiple jobs are collectively processed by a processing apparatus.

According to an example embodiment of the present disclosure, a processing control apparatus that controls a processing apparatus capable of executing first processing and second processing different from the first processing, includes a computer or processor configured or programmed to include an acquirer configured or programmed to acquire a job group including a plurality of jobs including a job that includes first processing data to execute the first processing and second processing data to execute the second processing, and a job that includes at least one of the first processing data or the second processing data, a first command generator configured or programmed to cause the processing apparatus to collectively execute the first processing corresponding to the first processing data included in the job group, and a second command generator configured or programmed to cause the processing apparatus to collectively execute the second processing corresponding to the second processing data included in the job group.

Other example embodiments of the present disclosure will be described in the present specification and with reference to the accompanying drawings.

According to example embodiments of the present disclosure, it is possible to reduce switching between different types of processing when multiple jobs are collectively processed by a processing apparatus.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is an explanatory view of an overall configuration of a processing system 100.

FIG. 2 is a block diagram of the processing system 100.

FIG. 3 is an explanatory view of data processing of a job A by a processing controller 71.

FIGS. 4A to 4C are reference explanatory views of processing according to the job A by a processing apparatus 1.

FIG. 5 is an explanatory view of data processing of a group job in a reference example.

FIG. 6 is an explanatory view of processing according to the group job in the reference example.

FIG. 7 is an explanatory view of data processing of the group job in an example embodiment of the present disclosure.

FIG. 8A is an explanatory view of a state in which the processing apparatus 1 executes printing according to a print command code ABC. FIGS. 8B and 8C are explanatory views of states in which the processing apparatus 1 cuts a medium M according to a cut command code ABC.

FIGS. 9A to 9C are explanatory views of a first modified example of an example embodiment of the present disclosure.

FIG. 10 is an explanatory view of a second modified example of an example embodiment of the present disclosure.

### DETAILED DESCRIPTION OF THE EXAMPLE EMBODIMENTS

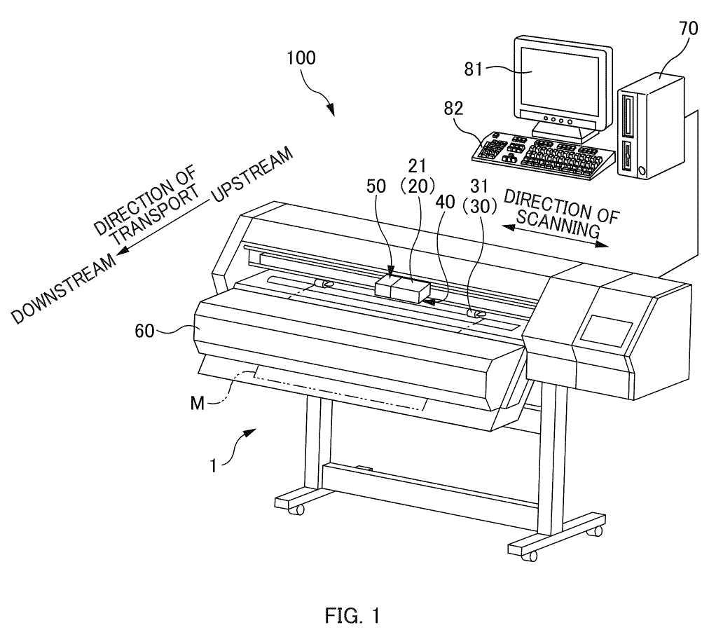

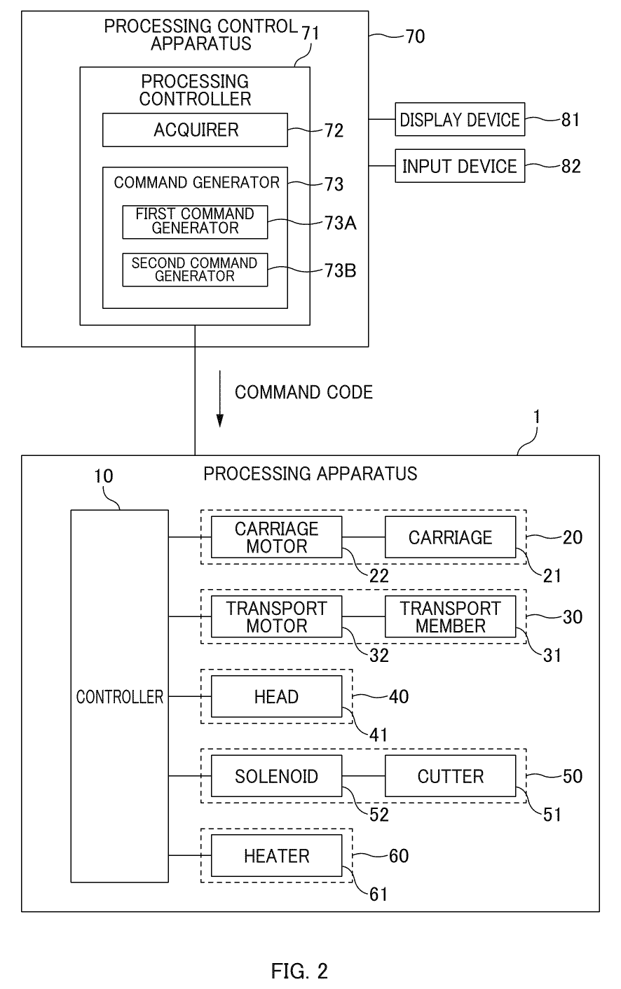

FIG. 1 is an explanatory view of an overall configuration of a processing system 100. FIG. 2 is a block diagram of the processing system 100.

In the following description, a direction in which a carriage 21 moves will be referred to as a "direction of scanning". The direction of scanning may also be referred to as a "main direction of scanning" or the "direction of movement". A direction in which a medium M moves during printing will be referred to as a "direction of transport", and a side from which the medium M is supplied will be referred to as "upstream (an upstream side)", and an opposite side (a side from which the medium M is discharged) will be referred to as "downstream (a downstream side)". The direction of transport may also be referred to as a "direction of sub-scanning". A direction from the downstream side toward the upstream side will be referred to as a "direction of reverse transport", and movement of the medium M in the direction of reverse transport may also be referred to as "reverse transport".

The processing system 100 is a system that processes the medium M. The medium M is a long, strip-shaped sheet, and is a medium to be processed. Examples of the medium M include roll paper, a film, cloth, and the like. The processing system 100 includes a processing apparatus 1 and a processing control apparatus 70. However, the processing system 100 may include only the processing apparatus 1, with the processing apparatus 1 executing functions of the processing control apparatus 70. Further, the processing apparatus 1 may implement some of the functions of the processing control apparatus 70, which will be described below.

The processing apparatus 1 is an apparatus to process the medium M. The processing apparatus 1 in the present example embodiment of the present disclosure executes, on the medium M, first processing and second processing different from the first processing. Herein, the description will be given assuming that the first processing is "printing" and the second processing is "cutting", for example. However, the processing executed on the medium M is not limited to printing and cutting. For example, the processing apparatus 1 may spray on the medium M. The processing apparatus 1 includes a controller 10, a carriage assembly 20, a transporter 30, a printer assembly 40, a cutter assembly 50, and a heater assembly 60.

The controller 10 is a controller (e.g., circuit) that is configured or programmed to control the processing apparatus 1. The controller 10 is configured or programmed to control respective elements (the carriage assembly 20, the transporter 30, the printer assembly 40, the cutter assembly 50, the heater assembly 60, and the like) of the processing apparatus 1 based on command codes from the processing control apparatus 70.

The carriage assembly 20 causes the carriage 21 to reciprocate in the direction of scanning. The carriage assembly 20 includes the carriage 21 and a carriage motor 22. The carriage 21 reciprocates in the direction of scanning. A head 41 and a cutter 51 are mounted to the carriage 21. The carriage 21 may include a head carriage and a cutter carriage and may be configured such that the head carriage and the cutter carriage are capable of being coupled to and separated from each other. The controller 10 is configured or programmed to control movement of the carriage 21 by controlling the carriage motor 22.

The transporter 30 transports the medium M. The transporter 30 includes a transport member 31 and a transport motor 32. The transport member 31 transports the medium M by rotating, like a transport roller, for example. The transport motor 32 is a drive source configured or programmed to cause the transport member 31 to rotate. The controller 10 is configured or programmed to control the transport (or the reverse transport) of the medium M by controlling the transport motor 32.

The printer assembly 40 prints an image on the medium M. The printer assembly 40 includes the head 41. The head 41 includes a nozzle to eject ink. The head 41 is mounted to the carriage 21 and is movable in the direction of scanning. The controller 10 is configured or programmed to control ejection of ink from the head 41.

The cutter assembly 50 cuts the medium M. The cutter assembly 50 includes the cutter 51 and a solenoid 52. The cutter 51 is a tool that has a blade edge to cut the medium M. The cutter 51 is mounted to the carriage 21 and is movable in the direction of scanning. The solenoid 52 is a driver that drives the cutter 51 in an up-down direction. The controller 10 is configured or programmed to control contact/non-contact between the blade edge of the cutter 51 and the medium M by controlling the solenoid 52.

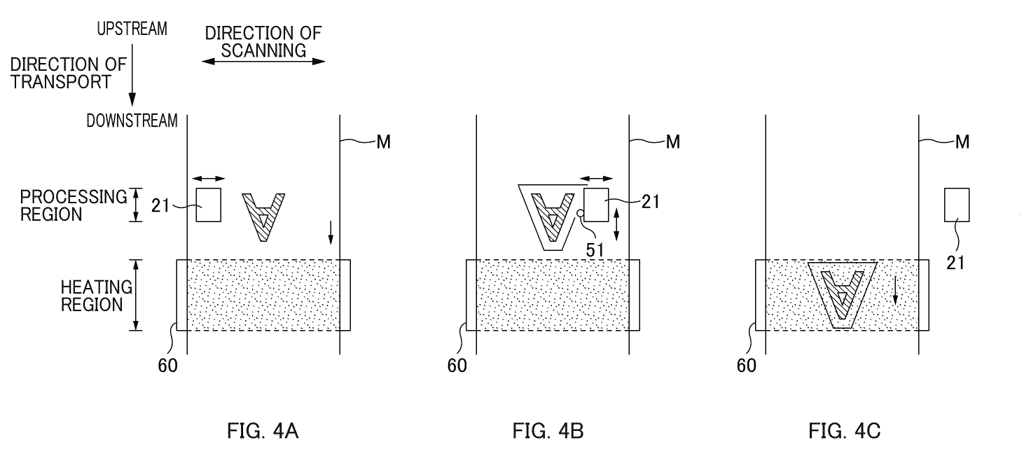

The heater assembly 60 heats the medium M. The image that is printed on the medium M can be dried by heating the medium M after printing. As will be described below, a heating region in which the heater assembly 60 heats the medium M is arranged on a downstream side in the direction of transport from a processing region in which the printer assembly 40 and the cutter assembly 50 process the medium M (a region in which the medium M faces the head 41 and the cutter 51) (see FIG. 4A). However, the position of the heater assembly 60 is not limited thereto, and the heater assembly 60 may be arranged in the processing region. The heater assembly 60 includes a heater 61. The heater assembly 60 may include a heating fan that blows hot air to the medium M instead of the heater 61. The controller 10 is configured or programmed to control heating of the medium M by controlling the heater 61. However, the processing apparatus 1 may not include the heater assembly 60.

The processing control apparatus 70 is configured or programmed to control the processing apparatus 1. The processing control apparatus 70 is configured or programmed to generate a command code to control the processing apparatus 1 and transmits the command code to the processing apparatus 1. The processing control apparatus 70 is configured or programmed to cause the processing apparatus 1 to execute processing according to the command code.

The processing control apparatus 70 may be a general-purpose personal computer. The processing control apparatus 70 includes, as hardware(circuit), an arithmetic processor (not illustrated), a storage device, and a communication device. The arithmetic processor includes a CPU and the like, for example. The storage device includes a main storage device such as RAM and an auxiliary storage device such as a hard disk drive, an SSD, and/or the like. The arithmetic processor executes a program stored in the storage device to implement various functions, which will be described below. The communication device includes a communication module, for example, to communicate with the processing apparatus 1. For example, the communication device transmits the command code to the processing apparatus 1 and receives a signal from the processing apparatus 1.

A display device 81 and an input device 82 are connected to the processing control apparatus 70. The processing control apparatus 70 can cause the display device 81 to display various screens. In addition, the processing control apparatus 70 can acquire information input through the input device 82.

The processing control apparatus 70 includes a processing controller 71. The processing controller 71 is configured or programmed to generate the command code to control the processing apparatus 1. The processing controller 71 is implemented by the processing control apparatus 70 (computer) executing a control program to control the processing apparatus 1. The processing controller 71 is configured or programmed to include an acquirer 72 and a command generator 73.

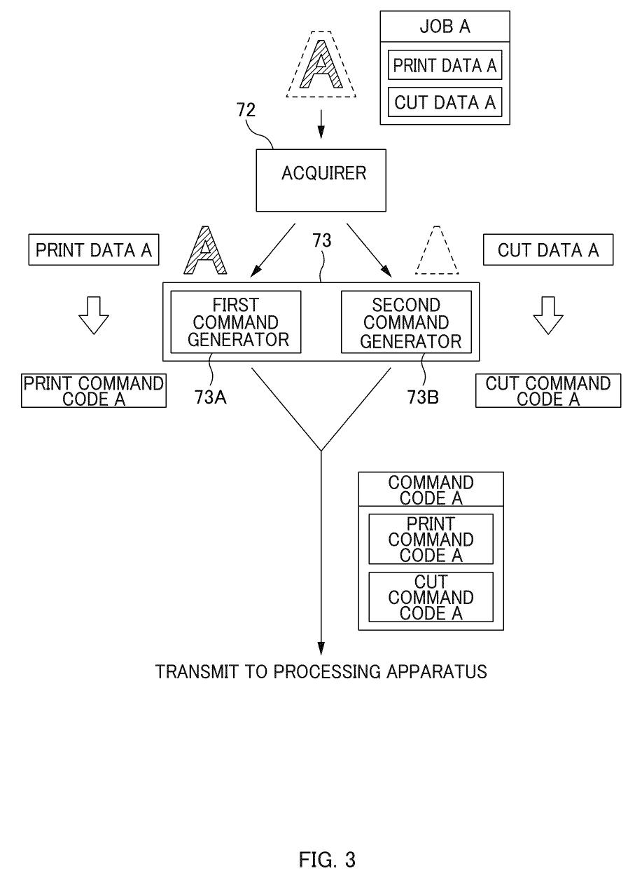

FIG. 3 is an explanatory view of data processing of a job A by the processing controller 71. Here, a description will be given of the case where the processing controller 71 is configured or programmed to cause the processing apparatus 1 to print an image A and cut along an outer periphery of the image A based on the job A. The job A in FIG. 3 includes data (print data A) to cause the processing apparatus 1 to print the image A and data (cut data A) to cause the processing apparatus 1 to cut along the outer periphery of the image A.

The acquirer 72 is configured or programmed to acquire a job. The job is data on a task to be executed by the processing apparatus 1 and includes at least one of first processing data to execute the first processing and second processing data to execute the second processing. Here, the first processing is "printing", and the second processing is "cutting", for example. Thus, the first processing data is "print data", and the second processing data is "cut data". The job A in FIG. 3 includes the print data A that corresponds to the first processing data and the cut data A that corresponds to the second processing data. The print data includes data on the image to be printed (image data), data on print settings (print setting data, for example, data on resolution, a layout, and the like), and the like. The cut data includes data on a cut line (for example, data on coordinates of a start point and an end point of the cut line) and the like. As will be described below, the acquirer 72 in the present example embodiment of the present disclosure can be configured or programmed to acquire a job group that includes multiple jobs. This point will be described below.

The command generator 73 is configured or programmed to cause the processing apparatus 1 to execute processing that corresponds to the job. Here, the command generator 73 transmits the command code to the processing apparatus 1, to cause the processing apparatus 1 to execute processing according to the command code. The command generator 73 is configured or programmed to generate the command code based on the job. The command generator 73 is configured or programmed to include a first command generator 73A and a second command generator 73B.

The first command generator 73A is configured or programmed to cause the processing apparatus 1 to execute the first processing that corresponds to the first processing data included in the job. Here, the first command generator 73A is configured or programmed to generate a print command code A serving as a command code to cause the processing apparatus 1 to execute printing based on the print data A (image data A and print setting data A) included in the job A. The print command code includes a code to control the movement of the carriage 21 during printing, a code to control ejection of ink from the head 41 during printing, a code to control the transport of the medium M during printing, and the like. The print command code also includes a code to control heating by the heater assembly 60 during printing.

The second command generator 73B is configured or programmed to cause the processing apparatus 1 to execute the second processing that corresponds to the second processing data included in the job. Here, the second command generator 73B generates a cut command code A serving as a command code to cause the processing apparatus 1 to execute cutting based on the cut data A included in the job A. The cut command code includes a code to control the movement of the carriage 21 during cutting, a code to control up-down movement of the cutter 51 (contact/non-contact between the blade edge of the cutter 51 and the medium M) during cutting, a code to control the transport of the medium M during cutting, and the like. The cut command code also includes a code to control heating by the heater assembly 60 during cutting.

The processing controller 71 is configured or programmed to transmit the command codes to the processing apparatus 1, to cause the processing apparatus 1 to execute the first processing and causes the processing apparatus 1 to execute the second processing. Here, the command generator 73 transmits, to the processing apparatus 1, a command code A that includes the print command code A and the cut command code A. The print command code A, which is generated by the first command generator 73A, is transmitted to the processing apparatus 1, and thereafter the cut command code A, which is generated by the second command generator 73B, is transmitted to the processing apparatus 1. However, the print command code A and the cut command code A may be transmitted simultaneously.

FIGS. 4A to 4C are reference explanatory views of the processing according to the job A by the processing apparatus 1.

The controller 10 in the processing apparatus 1 is configured or programmed to control each element or portion of the processing apparatus 1 according to the command code received from the processing controller 71, so as to execute the first processing and the second processing. Here, as illustrated in FIG. 4A, according to the print command code A, the controller 10 is configured or programmed to cause an operation of ejecting ink from the head 41 while moving the carriage 21 in the direction of scanning and an operation of transporting the medium M in the direction of transport to be executed alternately, so that the image A is printed on the medium M. After printing of the image A, as illustrated in FIG. 4B, the controller 10 brings the cutter 51 into contact with or away from the medium M according to the cut command code A, and causes relative movement between the cutter 51 and the medium M, to thereby form the cut line along the outer periphery of the image A printed on the medium M. The controller 10 causes the cutter 51 and the medium M to relatively move by combining the movement of the carriage 21 in the direction of scanning and the transport and reverse transport of the medium M, according to the cut command code A. The job A is executed when the processing apparatus 1 executes printing and cutting according to the print command code A and the cut command code A.

As illustrated in FIGS. 4A to 4C (and FIG. 1), the heater assembly 60 is arranged on the downstream side in the direction of transport with respect to the processing region in which the medium M faces the head 41 and the cutter 51. The controller 10 heats the medium M by the heater assembly 60 according to the command code. In FIGS. 4A to 4C, a region (heating region) that is heated by the heater assembly 60 is indicated by hatching. As illustrated in the drawings, the controller 10 heats (dries), by the heater assembly 60, the image A printed on the medium M according to the command code A. In FIG. 4C, the image is heated after cutting. However, the image may be heated before cutting, and the medium M may be cut after the image is heated. Further, the heater assembly 60 may heat the image printed on the medium M during processing such as printing, cutting, or the like. When a large image is printed on the medium M, the image printed on the medium M is heated by the heater assembly 60 during processing such as printing, cutting, or the like.

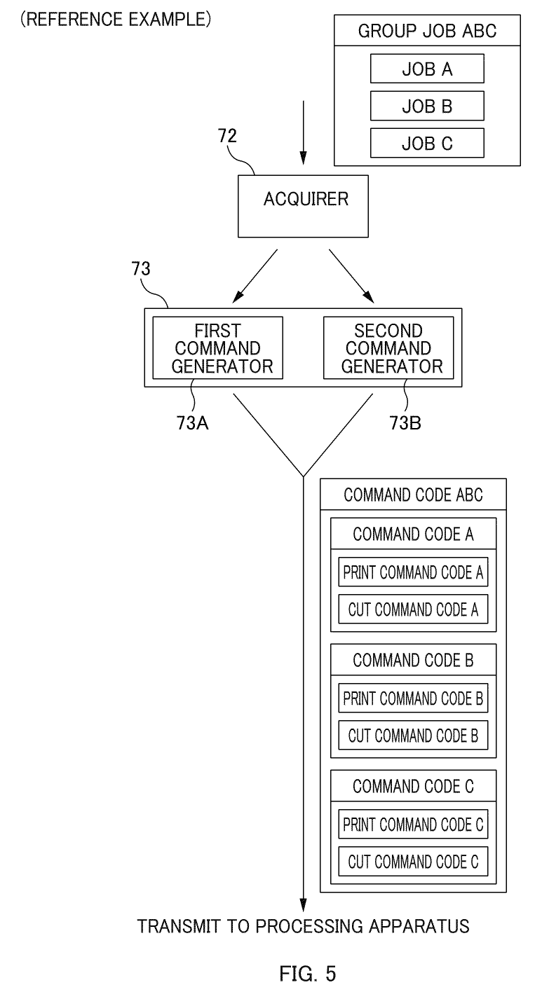

FIG. 5 is an explanatory view of data processing of a group job in a reference example.

The group job includes multiple jobs. When the multiple jobs are collectively processed by the processing apparatus 1 , the multiple jobs may be grouped to create a group job and the processing apparatus 1 may execute processing based on the group job. Here, a group job ABC includes the job A, a job B, and a job C. The job B and the job C each include the print data and the cut data, as with the job A. The print data in the job B and the job C may also be referred to as "print data B" and "print data C", respectively, and the cut data in the job B and the job C may also be referred to as "cut data B" and "cut data C", respectively.

In the reference example, the acquirer 72 is configured or programmed to acquire the group job ABC that includes the job A, the job B, and the job C. In addition, in the reference example, the processing controller 71 is configured or programmed to generate a command code ABC that includes the command code A, a command code B, and a command code C. As with the command code A illustrated in FIG. 3, the command code A illustrated in FIG. 5 is a command code that is generated based on the job A, and includes the print command code A, which is generated based on the print data A in the job A, and the cut command code A, which is generated based on the cut data A in the job A. The command code B is a command code that is generated based on the job B, and includes a print command code B that is generated based on the print data B in the job B, and a cut command code B that is generated based on the cut data B in the job B. The command code C is a command code that is generated based on the job C, and includes a print command code C that is generated based on the print data C in the job C and a cut command code C that is generated based on the cut data C in the job C.

In the reference example, the processing controller 71 is configured or programmed to transmit the command code ABC to the processing apparatus 1. The processing apparatus 1 that has received the command code ABC sequentially executes processing according to the command code A, the command code B, and the command code C included in the command code ABC, to thereby collectively execute the job A, the job B, and the job C. In the reference example, the processing apparatus 1 sequentially executes printing according to the print command code A, cutting according to the cut command code A, printing according to the print command code B, cutting according to the cut command code B, printing according to the print command code C, and cutting according to the cut command code C. In the reference example, the first processing (printing) and the second processing (cutting) are executed alternately. Accordingly, in the reference example, when the group job including the multiple jobs is executed, switching between the first processing and the second processing increases. However, when switching between the first processing and the second processing increases, processing efficiency degrades. For example, in the case where cutting is executed before printing, a head cleaning process is needed to prevent nozzle clogging when printing is resumed. Accordingly, when switching between printing and cutting increases, the head cleaning process needs to be executed frequently, which results in degraded processing efficiency.

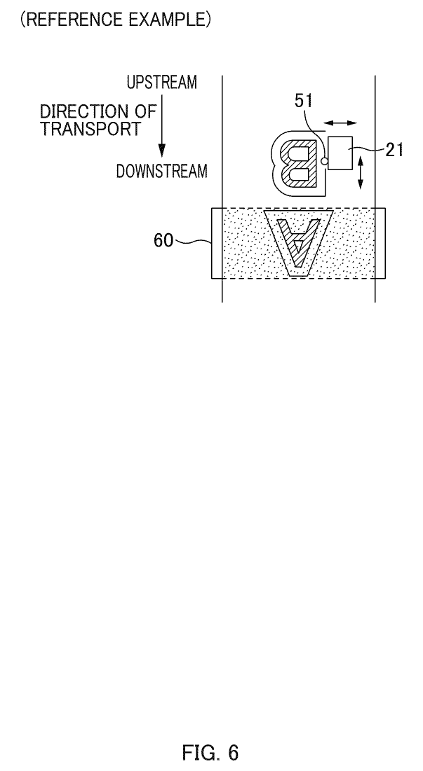

FIG. 6 is an explanatory view of the processing according to the group job in the reference example.

In the reference example, the image A printed on the medium M is heated by the heater assembly 60 while the job B is executed. In the reference example, a region of the image A is positioned in the heating region (the region indicated by hatching in FIG. 6) not only during a printing time of an image B but also during a cutting time of a cut line B. As such, in the reference example, a time period during which the medium M passes through the heating region increases, and the medium M may be heated excessively. In addition, when the medium M where the cut line has been formed is excessively heated, the medium M may curl up at the cut line due to shrinkage of the medium M caused by heating. Thus, in the reference example, not only the processing efficiency is degraded, but also the processing accuracy may also be degraded. In the reference example, the time period during which the medium M passes through the heating region varies depending on the contents of the processing executed on the upstream side in the direction of transport, and thus it is difficult to control a heating time.

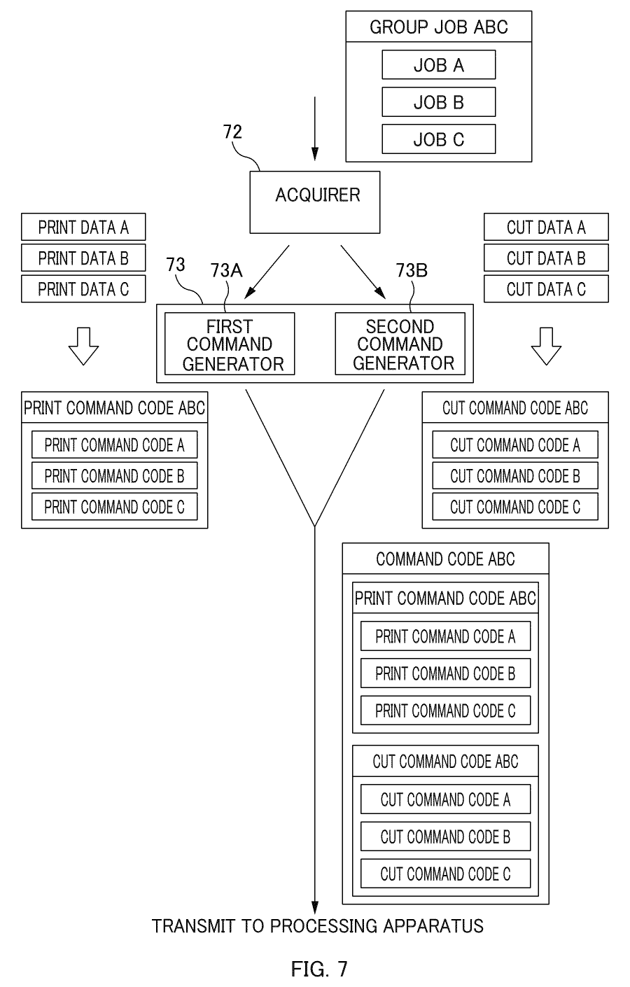

FIG. 7 is an explanatory view of the data processing of the group job in the present example embodiment of the present disclosure.

The acquirer 72 is configured or programmed to acquire the group job that includes the multiple jobs. Here, the acquirer 72 is configured or programmed to acquire the group job ABC that includes the job A, the job B, and the job C. As described above, each of the jobs of the group job includes the first processing data (print data) and the second processing data (cut data).

The first command generator 73A is configured or programmed to extract the first processing data that is included in the group job to generate a command code to cause the processing apparatus 1 to collectively execute the first processing. Here, the first command generator 73A is configured or programmed to extract the print data A included in the job A, the print data B included in the job B, and the print data C included in the job C of the group job ABC, to generate the print command code ABC. The print command code ABC includes the print command code A generated based on the print data A in the job A, the print command code B generated based on the print data B in the job B, and the print command code C generated based on the print data C in the job C. The print command code ABC is a command code to cause the processing apparatus 1 to collectively execute printing according to the print data (first processing data) included in the group job ABC. Through the print command code ABC, the first command generator 73A causes the processing apparatus 1 to collectively execute printing according to the print data (the first processing data) included in the group job ABC.

Similarly, the second command generator 73B is configured or programmed to extract the second processing data that is included in the group job to generate a command code to cause the processing apparatus 1 to collectively execute the second processing. Here, the second command generator 73B extracts the cut data A included in the job A, the cut data B included in the job B, and the cut data C included in the job C of the group job ABC, to generate the cut command code ABC. The cut command code ABC includes the cut command code A generated based on the cut data A in the job A, the cut command code B generated based on the cut data B in the job B, and the cut command code C generated based on the cut data C in the job C. The cut command code ABC is a command code to cause the processing apparatus 1 to collectively execute cutting according to the cut data (the second processing data) included in the group job ABC. Through the cut command code ABC, the second command generator 73B causes the processing apparatus 1 to collectively execute cutting according to the cut data included in the group job ABC.

The processing controller 71 is configured or programmed to transmit the command codes to the processing apparatus 1, to cause the processing apparatus 1 to execute the first processing and cause the processing apparatus 1 to execute the second processing. Here, the processing controller 71 is configured or programmed to transmit, to the processing apparatus 1, the command code ABC that includes the print command code ABC and the cut command code ABC. Here, the print command code ABC is transmitted to the processing apparatus 1, and thereafter the cut command code ABC is transmitted to the processing apparatus 1. However, the print command code ABC and the cut command code ABC may be transmitted simultaneously.

The processing apparatus 1 that has received the command code executes the processing according to the command code. In the present example embodiment of the present disclosure, the processing apparatus 1 that has received the command code ABC executes printing according to the print command code ABC included in the command code ABC, and thereafter executes cutting according to the cut command code ABC. That is, in the present example embodiment of the present disclosure, the processing apparatus 1 sequentially executes printing according to the print command code A, printing according to the print command code B, and printing according to the print command code C, and thereafter sequentially executes cutting according to the cut command code A, cutting according to the cut command code B, and cutting according to the cut command code C. In the present example embodiment of the present disclosure, after the multiple first processing operations (printing) included in the group job are executed, the multiple second processing operations (cutting) are collectively executed. Thus, in the present example embodiment of the present disclosure, when the group job that includes the multiple jobs is executed, it is possible to reduce switching between the first processing and the second processing as compared to the reference example.

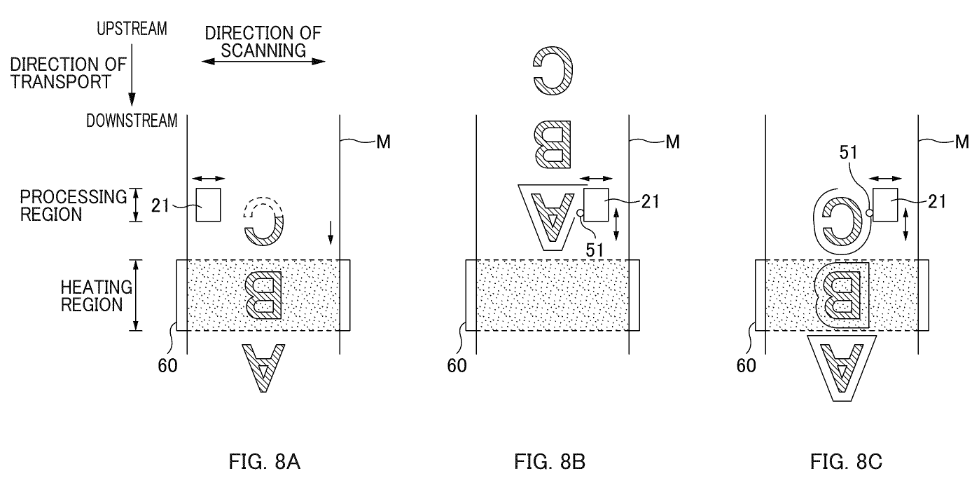

FIG. 8A is an explanatory view of a state in which the processing apparatus 1 executes printing according to the print command code ABC.

The processing apparatus 1 sequentially prints the image A, the image B, and an image C according to the print command code A, the print command code B, and the print command code C that are included in the print command code ABC. In this way, printing according to the print data (the print data A to C) included in the group job ABC is collectively executed. Here, printing of the image A, the image B, and the image C is collectively executed, and thus it is possible to reduce the number of times of the head cleaning processes as compared to the reference example, thereby being able to reduce a total time needed for printing that includes the head cleaning processes during printing.

The image printed on the medium M is heated by the heater assembly 60. FIG. 8A illustrates a state in which the image B is heated by the heater assembly 60 during printing of the image C. At this stage, the medium M is not cut. Thus, as compared to the reference example illustrated in FIG. 6, it is possible to reduce a time period during which the printed image passes through the heating region (the region indicated by hatching in the drawings) to reduce or prevent excessive heating of the medium M. When printing the image, the processing apparatus 1 repeats, at predetermined time intervals, a transport operation of transporting the medium M by a predetermined transport amount in the direction of transport. Thus, the time period during which the medium M passes through the heating region during printing is substantially constant. For this reason as well, in the present example embodiment of the present disclosure, the medium M is not excessively heated during printing.

FIGS. 8B and 8C are explanatory views of states in which the processing apparatus 1 cuts the medium M according to the cut command code ABC.

After finishing printing the images, the processing apparatus 1 reversely transports the medium M. When the medium M is reversely transported, the images (the image A, the image B, and the image C) that are printed on the medium M are positioned on the upstream side with respect to the heater assembly 60 in the direction of transport. After the reverse transport, the processing apparatus 1 sequentially executes cutting according to the cut command code A, the cut command code B, and the cut command code C included in the cut command code ABC. In this way, cutting according to the cut data (cut data A to C) included in the group job ABC is collectively executed.

The image obtained by cutting along the outer periphery is heated by the heater assembly 60. FIG. 8C illustrates the state in which the image B passes through the heating region (the region indicated by hatching in the drawing) during cutting along the outer periphery of the image C. Since the image has been already printed, it is possible to reduce the time period during which the cut image passes through the heating region as compared to the reference example illustrated in FIG. 6. That is, in the case where the processing is executed as in the reference example (see FIG. 6), the time period during which the cut image passes through the heating region is a total of a printing time of the subsequently printed image (the image C) and a cutting time while subsequently cutting along a cut line (a cut line C). Meanwhile, in the case where the processing illustrated in FIG. 8C is executed, the time period during which the cut image passes through the heating region is only the cutting time while subsequently cutting along the cut line (the cut line C). Thus, as compared to the reference example, it is possible to reduce the time period during which the cut image passes through the heating region by the amount of time period for printing. For this reason, even when the medium M is heated in the heating region during cutting, excessive heating of the medium M can be suppressed as compared to the reference example.

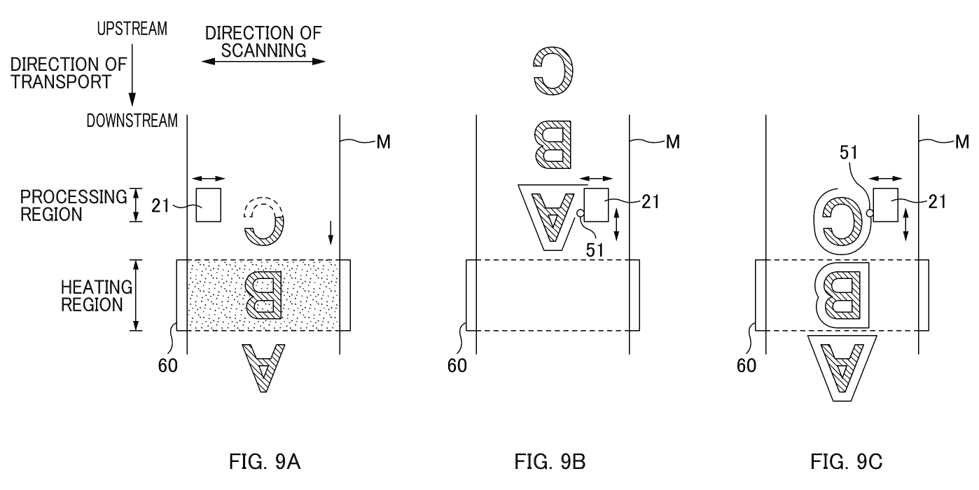

FIGS. 9A to 9C are explanatory views of a first modified example. FIG. 9A is an explanatory view of a state in which the processing apparatus 1 executes printing according to the print command code ABC. FIG. 9A is the same as FIG. 8A. FIGS. 9B and 9C illustrate states in which the processing apparatus 1 turns off the heater assembly 60.

In the first modified example of an example embodiment of the present disclosure, while cutting the medium M, the processing apparatus 1 reduces the heating by the heater assembly 60. In this way, it is possible to prevent the medium M from curling up at the cut line due to shrinkage of the medium M by heating. Note that the method for reducing the heating by the heater assembly 60 is not limited to turning off the heater assembly 60. For example, the temperature of the heating region may be lowered without turning off the heater assembly 60. In short, as long as heating by the heater assembly 60 during cutting is weaker than heating by the heater assembly 60 during printing, it is possible to prevent the medium M from curling up at the cut line. In the first modified example, the second command generator 73B generates the cut command code ABC including such a code that heating by the heater assembly 60 during cutting is reduced as compared to heating by the heater assembly 60 during printing.

The first command generator 73A described above is configured or programmed to generate the print command code based on the print data, and the second command generator 73B is configured or programmed to generate the cut command code based on the cut data. However, the first command generator 73A and the second command generator 73B may not be configured or programmed to generate the print command code based on the print data and to generate the cut command code based on the cut data. For example, the acquirer 72 may be configured or programmed to generate the print command code based on the print data and to generate the cut command code based on the cut data.

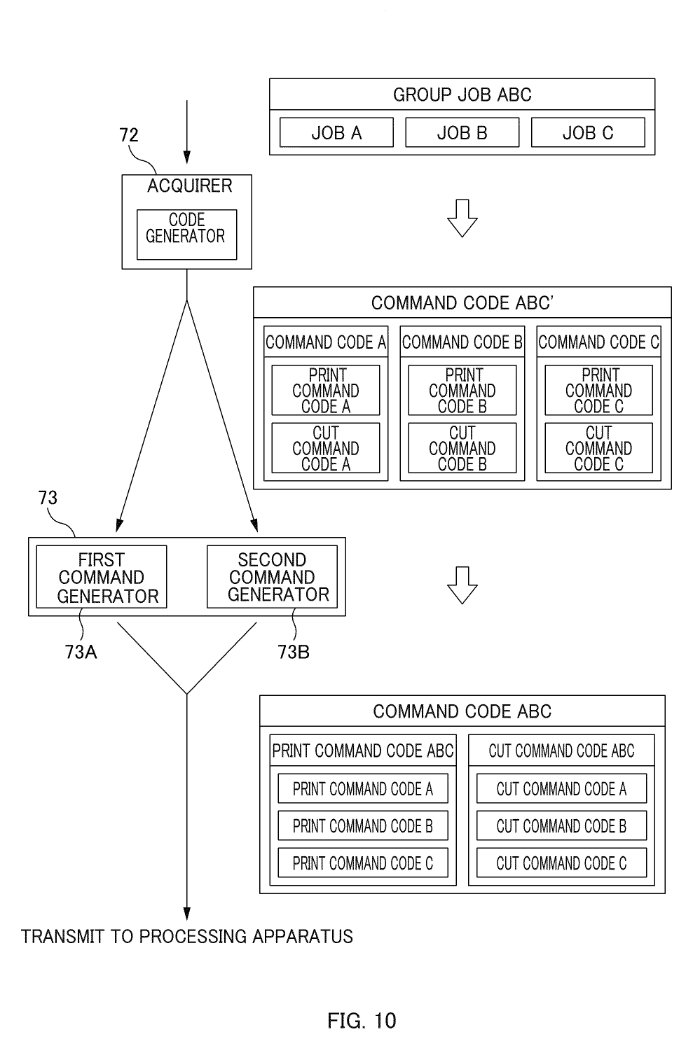

FIG. 10 is an explanatory view of a second modified example of an example embodiment of the present disclosure.

In the second modified example, the acquirer 72 is configured or programmed to acquire the group job ABC that includes the job A, the job B, and the job C. The acquirer 72 in the second modified example is configured or programmed to generate a command code ABC' that includes the command code A, the command code B, and the command code C. As such, in the second modified example, the acquirer 72 is configured or programmed to generate the print command code based on the print data included in the job and to generate the cut command code based on the cut data included in the job.

The first command generator 73A in the second modified example is configured or programmed to extract the print command codes (the print command codes A to C) that are included in the command code ABC' generated by the acquirer 72, and generate the print command code ABC. The print command code ABC in the second modified example includes the print command code A generated based on the print data A in the job A, the print command code B generated based on the print data B in the job B, and the print command code C generated based on the print data C in the job C. The print command code ABC is the command code to cause the processing apparatus 1 to collectively execute printing according to the print data (the first processing data) included in the group job ABC. Through the print command code ABC, the first command generator 73A causes the processing apparatus 1 to collectively execute printing according to the print data (the first processing data) included in the group job ABC.

Similarly, the second command generator 73B in the second modified example is configured or programmed to extract the cut command codes (the cut command codes A to C) that are included in the command code ABC' generated by the acquirer 72, and generate the cut command code ABC. The cut command code ABC is a command code to cause the processing apparatus 1 to collectively execute cutting according to the cut data (the second processing data) included in the group job ABC. Through the cut command code ABC, the second command generator 73B causes the processing apparatus 1 to collectively execute cutting according to the cut data (the second processing data) included in the group job ABC.

In the second modified example as well, the processing controller 71 is configured or programmed to transmit, to the processing apparatus 1, the command code ABC that includes the print command code ABC and the cut command code ABC. In the second modified example as well, the processing apparatus 1 executes printing according to the print command code ABC included in the command code ABC and thereafter executes cutting according to the cut command code ABC. The processing by the processing apparatus 1 in the second modified example is the same as the processing that has been already described. Thus, the description thereof is omitted.

The processing control apparatus 70 according to the present example embodiment controls the processing apparatus 1 capable of executing the first processing (for example, printing) and the second processing (for example, cutting). The processing control apparatus 70 is configured or programmed to include the acquirer 72 configured or programmed to acquire a group job including a plurality of jobs, the first command generator 73A configured or programmed to cause the processing apparatus 1 to collectively execute the first processing corresponding to the first processing data (for example, print data) included in the job group, and the second command generator 73B configured or programmed to cause the processing apparatus 1 to collectively execute the second processing corresponding to the second processing data (for example, cut data) included in the job group (see FIGS. 7 and 10). This makes it possible to reduce switching between the first processing and the second processing when the plurality of jobs is processed by the processing apparatus 1.

In the above description, the processing control apparatus 70 includes the computer, and the acquirer 72, the first command generator 73A, and the second command generator 73B are provided outside the processing apparatus 1. However, the processing controller 70 is not limited to a computer provided outside the processing apparatus 1. For example, the controller 10 in the processing apparatus 1 may be configured or programmed to include the acquirer 72, the first command generator 73A, and the second command generator 73B, and the controller 10 in the processing apparatus 1 may be configured or programmed to function as the processing control apparatus 70. Alternatively, with some of the functions of the acquirer 72, the first command generator 73A, and the second command generator 73B being provided by the controller 10 in the processing apparatus 1, the processing control apparatus 70 may be a computer outside the processing apparatus 1 and the controller 10 in the processing apparatus 1.

In the above description, all the jobs of the group job each include both the first processing data (for example, the print data) and the second processing data (for example, the cut data). However, the job of the group job is not limited to that including both the first processing data and the second processing data, and it only needs to include at least one of the first processing data or the second processing data. In the present example embodiment of the present disclosure, at least one of the plurality of jobs of the group job only needs to include both the first processing data (for example, the print data) and the second processing data (for example, the cut data), and other jobs only need to include at least one of the first processing data or the second processing data. As such, in the case where the job group includes the plurality of jobs, and the plurality of jobs include the job including the first processing data to execute the first processing and the second processing data to execute the second processing, and the job including at least one of the first processing data or the second processing data, the present example embodiment of the present disclosure is effective.

In the present example embodiment, the first command generator 73A is configured or programmed to cause the processing apparatus 1 to sequentially execute the first processing in the order of the plurality of jobs included in the group job. Specifically, the group job ABC includes the job A, the job B, and the job C in this order, the first command generator 73A causes the processing apparatus 1 to sequentially execute printing of the image A corresponding to the job A, printing of the image B corresponding to the job B, and printing of the image C corresponding to the job C, and the second command generator 73B causes the processing apparatus 1 to sequentially execute cutting corresponding to the job A, cutting corresponding to the job B, and cutting corresponding to the job C. This makes it possible to cut the image A according to the job A, cut the image B according to the job B, and cut the image C according to the job C. That is, each of the first processing and the second processing can be executed collectively, while maintaining a correspondence relationship between the first processing data and the second processing data that are included in each of the job included in the group job acquired by the acquirer 72.

In the above description, the first processing is printing, and the second processing is cutting. However, the first processing and the second processing are not limited thereto. For example, the first processing may be cutting, and the second processing may be printing. That is, after cutting is collectively executed as the first processing, printing may be collectively executed as the second processing. As such, when the first processing is one of printing and cutting, and the second processing is the other of printing and cutting, printing and cutting can be executed on the medium M. Note that the processing with respect to the medium M is not limited to printing and cutting. For example, the first processing may be printing or cutting and the second processing may be spraying, and alternatively, the first processing may be spraying, and the second processing may be printing or cutting.

In the processing control apparatus 70 described above, the first command generator 73A is configured or programmed to cause the first processing to be executed on the medium M while causing the medium to be heated, and the second command generator 73B is configured or programmed to cause the second processing to be executed on the medium M, while reducing the heating of the medium M as compared to heating during execution of the first processing. This makes it possible to reduce or prevent shrinkage of the medium M caused by heating.

In particular, in the processing control apparatus 70 described above, the first command generator 73A is configured or programmed to cause printing to be executed on the medium M as the first processing, while causing the medium M to be heated, and the second command generator 73B is configured or programmed to cause cutting to be executed on the medium M as the second processing, while reducing the heating of the medium M as compared to heating during execution of the first processing (here, printing). This makes it possible to prevent the medium M from curling up at the cut line due to the shrinkage of the medium M by heating. Note that in the case where cutting is executed as the first processing and then printing is executed as the second processing as well, the medium M may be cut while the heating of the medium M is reduced as compared to the heating during printing.

As illustrated in FIGS. 8A to 8C, as in the case where the first processing is executed, the medium M may be heated by the heater assembly 60 when the second processing is executed. Alternatively, the processing apparatus 1 may not include the heater assembly 60, and the medium M may not be heated when the first processing and the second processing are executed. Even in these cases, it is possible to reduce switching between the first processing and the second processing when the group job is executed by collectively executing the plurality of the first processing operations (for example, printing) included in the group job and collectively executing the plurality of the second processing operations.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A processing control apparatus that controls a processing apparatus capable of executing first processing and second processing different from the first processing, the processing control apparatus comprising:
a computer or processor configured or programmed to include:
an acquirer configured or programmed to acquire a job group including a plurality of jobs including a job that includes first processing data to execute the first processing and second processing data to execute the second processing, and a job that includes at least one of the first processing data or the second processing data;
a first command generator configured or programmed to cause the processing apparatus to collectively execute the first processing corresponding to the first processing data included in the job group; and
a second command generator configured or programmed to cause the processing apparatus to collectively execute the second processing corresponding to the second processing data included in the job group.

2. The processing control apparatus according to claim 1, wherein the first command generator is configured or programmed to cause the processing apparatus to sequentially execute the first processing in an order of the plurality of jobs included in the job group, and the second command generator is configured or programmed to cause the processing apparatus to sequentially execute the second processing in the order of the plurality of jobs.

3. The processing control apparatus according to claim 1, wherein the first processing includes one of printing and cutting, and the second processing includes the other of printing and cutting.

4. The processing control apparatus according to claim 1, wherein the first command generator is configured or programmed to cause the first processing to be executed on a medium, while causing the medium to be heated, and the second command generator is configured or programmed to cause the second processing to be executed on the medium, while reducing heating of the medium as compared to heating during execution of the first processing.

5. The processing control apparatus according to claim 1, wherein the first command generator is configured or programmed to cause printing to be executed on a medium as the first processing, while causing the medium to be heated, and the second command generator is configured or programmed to cause cutting to be executed on the medium as the second processing, while reducing heating of the medium as compared to heating during execution of the first processing.

6. The processing control apparatus according to claim 1, wherein
the first command generator is configured or programmed to extract the first processing data from each of the jobs included in the job group, to generate a first command code to cause the processing apparatus to collectively execute the first processing; and
the second command generator is configured or programmed to extract the second processing data from each of the jobs included in the job group, to generate a second command code to cause the processing apparatus to collectively execute the second processing.

7. The processing control apparatus according to claim 6, wherein the processing control apparatus is configured or programmed to transmit the first command code and the second command code to the processing apparatus.

8. The processing control apparatus according to claim 1, wherein
the acquirer is configured or programmed to generate a command code to cause the processing apparatus to execute the first processing and the second processing, respectively, based on the first processing data and the second processing data of each of the jobs included in the job group;
the first command generator is configured or programmed to extract the command code to cause the first processing to be executed that is included in the command code generated by the acquirer, to generate a first command code to cause the processing apparatus to collectively execute the first processing; and
the second command generator is configured or programmed to extract the command code to cause the second processing to be executed that is included in the command code generated by the acquirer, to generate a second command code to cause the processing apparatus to collectively execute the second processing.

9. A processing control method to cause a processing apparatus to execute first processing and second processing different from the first processing, the processing control method comprising:
acquiring a job group that includes a plurality of jobs including a job that includes first processing data to execute the first processing and second processing data to execute the second processing, and a job that includes at least one of the first processing data or the second processing data;
causing the processing apparatus to collectively execute the first processing corresponding to the first processing data included in the job group; and
causing the processing apparatus to collectively execute the second processing corresponding to the second processing data included in the job group.
